(19) United States
(12) Patent Application Publication
(10) Pub. No.: US 2006/0053680 A1
(43) Pub. Date: Mar. 16, 2006

(54) Reversible diverter for use with fishing lures

(76) Inventor: Marc Petitjean, Fribourg (CH)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/226,091

(22) Filed: Sep. 14, 2005

Related U.S. Application Data
(60) Provisional application No. 60/700,864, filed on Jul. 19, 2005.

(30) Foreign Application Priority Data
Sep. 15, 2004 (CH) 01517/04
Sep. 23, 2004 (CH) 01557/04
Sep. 23, 2004 (CH) 01558/04

(51) Int. Cl. A01K 85/00

(52) U.S. Cl. 43/42.47; 43/42.06

(57) ABSTRACT

The invention relates to a fishing device that is convenient and versatile. The fishing device is a diverter and includes a sleeve and a cup attached to the sleeve. The cup is reversible and the sleeve is flexible. The diverter is adapted for use in conjunction with a lure, and forms an improved lure assembly therewith. The sleeve can be mounted on a lure, thereby securing the cup to the lure. The cup has an open position which produces movement by the lure assembly. The cup can be manually moved to a closed position. In the closed position, the diverter streamlines the flow of water around the lure. The fishing device can be separate, or can integrally extend, from a lure body. The fishing device can be irregular or symmetric, and can take a variety of cross-sectional shapes and configurations.

### CROSS-REFERENCE TO RELATED APPLICATIONS

This application claims the benefit of priority to Swiss Patent Application No. 01517/04, filed in the Swiss Federal Institute of Intellectual Property on Sep. 15, 2004 and entitled “TÊTE DE MOUCHE ARTIFICIELLE POUR LA PÊCHE” (“HEAD OF ARTIFICIAL FLY FOR FISHING”), Swiss Patent Application No. 01557/04, filed in the Swiss Federal Institute of Intellectual Property on Sep. 23, 2004 and entitled “TÊTE DE MOUCHE ARTIFICIELLE IRRÉGULIÈRE POUR LA PÊCHE” (“IRREGULAR HEAD OF ARTIFICIAL FLY FOR FISHING”), and Swiss Patent Application No. 01558/04, filed in the Swiss Federal Institute of Intellectual Property on Sep. 23, 2004 and entitled “TÊTE DE MOUCHE ARTIFICIELLE AJOURÉE POUR LA PÊCHE” (“PERFORATED HEAD OF ARTIFICIAL FLY FOR FISHING”), each of which are incorporated herein in their entirety by reference. This application also claims priority to and the benefit of U.S. Provisional Patent Application Ser. No. 60/700,864, entitled “REVERSIBLE DIVERTER FOR USE WITH FISHING HOOKS AND LURES,” which was filed on Jul. 19, 2005, and which is incorporated herein by reference in its entirety.

### BACKGROUND OF THE INVENTION

1. The Field of the Invention

The present application relates to the field of fishing. More particularly, the present invention is directed to a fishing device that can be used to provide a multiple configuration fishing lure assembly having adjustable positions.

2. The Relevant Technology

Since ancient times, fishing has been relied on as a food source. Ancient records and archeological research demonstrate that ancient anglers employed spears and hooks made from bone and wood in order to catch their meals. While fishing remains a major food industry in the modern world, it has also become popular as a sport and means of recreation.

As time has progressed, fishing tackle has simultaneously evolved and become more sophisticated. The ancient hook has evolved into sophisticated metal hooks with complex designs. Natural baits such as worms, salmon eggs, and cheese are still common forms of catching fish, but artificial lures, including jigs, spoons, spinners, and artificial flies, have replaced many of the natural baits. Modern tackle and fly shops continually attract angers with the lures and bait most likely to catch the largest numbers and sizes of fish.

The term “fishing lure” or “lure” as employed in this specification and the appended claims relates to a vast array of fishing tackle including, by way of example, but not limited to, a hook, baited hook, artificial fly, artificial spinner, artificial spoon, artificial bait (e.g., artificial simulation of a fish, frog, other amphibian, animal, insect, reptile, salmon egg, worm and other simulated food sources for fish), dry fly, wet fly, caddis, plug, midge, scud, nymph, streamer, whistler, hairwig, fishing tackle commonly referred to as a “fly” or “lure,” and various additional objects which are designed to be used in fishing or to stimulate the natural instinct of a fish to strike.

One feature of artificial lures which is typically employed to attract fish, particularly in spinners, spoons, and artificial bait, is the use hydrodynamics to stimulate movement of the lure as it moves through the water. The hydrodynamic design may cause the artificial lure to move randomly, or may attempt to simulate the natural movement of fish prey. Often, this natural movement may include staggered side-to-side or up-and-down motion which simulates a wounded bait fish. However, conventional devices and methods for creating fishing lures with some degree of movement require the design to be implemented by the manufacturer of the artificial lure, or require tedious and complicated alterations to the lure, all of which typically fail to simulate the natural movement of the imitated bait.

Some anglers are especially adept and have developed the ability to identify the feeding patterns of particular species of fish and/or the hatching patterns of particular insects. It is not uncommon for these anglers to initially examine the bank of a stream or river, such as by reviewing a sample of the soil on the bank. These anglers then determine the lure which is most likely to be successful (such as an artificial fly matching the flies which are hatching and floating on the surface of the stream) given the conditions of the stream or river that day.

Since fishing conditions can even change during the day, it is almost impossible to predict with perfect accuracy the fishing lure which will be the most successful for a particular fishing expedition at any given time. Consequently, anglers typically carry various fishing lures in their tackle box in anticipation of varying conditions. Some anglers even carry the building materials for lures with them as they leave their vehicle and walk to a particular fishing hole. Many of these anglers examine the conditions of the fishing hole during that time of day, then tie a fly, for example, which is believed to be the most likely to be successful for them during that particular time of day.

Sometimes anglers do not know which lure they should use until they are in chest deep water wading in the middle of a rushing river. Typical anglers wear pocket-laden fishing vests with different lures in organized compartments in an attempt to avoid the often tortuous, slippery, and time consuming path back to a tackle box on the shore. However, it is not always possible to predict which lure to place in the vest and tying a particular fly in the middle of a rushing river is a challenge if not impossible even for experienced anglers. Such fly tying generally requires the use of a fly tying vise or other holder and a variety of different components and tools. Thus, wading anglers are typically limited to the lures already in their vest.

Even the most knowledgeable anglers sometimes must resort to trial-and-error to determine which lure will catch the fish. With each unsuccessful lure, the angler must remove the lure and attach a new one in hopes of finding something that will awaken the fish's natural instincts. In such a case, the angler may be removing a lure and attaching a new lure every few minutes, which further increases the speed at which the angler runs through the supply of lures. The frequent repetition of removal and attachment of flies also causes the angler to lose valuable time which could otherwise be spent tying to catch fish.

There is, therefore, a need in the art for a device which may be combined with a fishing lure to allow the same lure to be used in multiple manners. There is also a need in the art for a device or lure which effectively stimulates the instincts of a fish to strike.

### BRIEF SUMMARY OF THE INVENTION

The invention relates to a reversible diverter for use with fishing lures, and which facilitates the use of a lure in a variety of manners, with minimal effort to change between methods of use. The reversible diverter is part of a lure assembly of the present invention. The lure assembly comprises the diverter and a lure on which the diverter is mounted. In an exemplary embodiment, the reversible diverter comprises a cup and a sleeve configured to facilitate mounting of the diverter on a lure. The cup is reversible with respect to its position on the sleeve. The diverter can be mounted on a lure to form a lure assembly having a variety of different advantages.

In one exemplary embodiment, the sleeve has a hollow channel therein such that it can receive and be positioned around the shank of a hook or otherwise mounted on a lure. When the cup is open, it displaces water as the diverter is moved through the water. When the cup is reversed to a closed position, it streamlines the flow of water around the lure. Thus, the cup is configured to allow a user to quickly change or modify the motion or appearance of a lure. The ease of modifying a lure's motion or appearance enables a consumer to easily use the same lure to meet changing fishing conditions.

The cup is configured in such a way that it can be reversed so as to change the dynamic of the lure assembly. For instance, one embodiment utilizes a flexible cup attached to a flexible sleeve. The cup can be positioned in a first, frontal, open position which is convex with respect to the sleeve and, when mounted on a lure, creates an oscillating or random motion. The cup can also have a second, rear, closed position which streamlines the motion of the lure. In this second position, the cup can be concave with respect to the sleeve. Thus, the cup is convex in the open position and creates an oscillating or random motion of the lure assembly, while the cup is concave in the rear position and streamlines the flow of water around the lure assembly.

The cup can be configured to resist inadvertent reversal when in use. Accordingly, the cup can resist underwater repositioning of the diverter from the first, open position to the second, closed position, and allow such reconfiguration only under the application of manual pressure.

In the first position, the cup faces away from the sleeve such that the cup is open and as the cup moves through the water, water contacts an inner surface of the cup and creates pressure which causes the lure to move in an oscillating or random motion. In the second position, the flexible cup is folded over the sleeve and/or lure, and is thereby closed so as to facilitate movement of water around the lure. In some embodiments, facilitating the movement of water around a lure streamlines the flow of water around the lure assembly. Accordingly, in a first position the reversible diverter can induce motion in a lure, while in the second position, the reversible diverter can have a streamlining effect on the lure.

In one embodiment, the flexible cup is substantially bell-shaped and symmetrical, and creates an oscillating motion when the lure assembly is moved through the water. In another embodiment, the flexible cup is irregular in shape. For instance, one or more holes, orifices, or slots may be formed in the cup, or the cup may be slanted. The irregular cup can be adapted to provide random motion when moved through water.

The sleeve may be an expandable sleeve that can flex or otherwise expand to facilitate mounting the reversible diverter on a lure. In some embodiments the lure is a hook and the sleeve is expanded to fit over the barb or eye of the hook, or to be mounted on any of a variety of sized hooks. In one embodiment, the sleeve is a flexible sleeve that has a smaller diameter than the hook shank, such that it compresses against the hook shank to mount the reversible diverter thereon. Alternatively, or in addition to, the compression fit, the sleeve may be tied to or adhesively mounted on the lure.

The lure may further comprise additional materials mounted on the hook, such as fly tying materials or components. Thus, the lure employed in the present invention may be a fishing fly upon which the diverter is mounted. Upon mounting a reversible diverter on a lure, the lure assembly is formed. The lure assembly may also include a tube or a wire on which a hook and/or the diverter is mounted. The sleeve may be inserted over the tube or wire, or otherwise mounted thereon.

As mentioned above, in one embodiment, the reversible diverter comprises a sleeve configured to be mounted on a lure, and a cup coupled to the sleeve. In another embodiment, the reversible diverter comprises a cup integrally extending from or otherwise mounted on a lure without a sleeve. Thus, in some embodiments, a fishing lure assembly of the present invention includes a reversible diverter comprising a cup mounted on (e.g. integrally extending from) a lure comprising a lure body and a hook. The lure body may further be adapted to allow an angler to attract a fish, and may be, for example, rigid or soft, or may include fly-tying materials.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A is a perspective view illustrating a reversible diverter according to one embodiment of the invention;

FIG. 1B is a cross-sectional view of the reversible diverter illustrated in FIG. 1A;

FIG. 2 is a perspective view illustrating a reversible diverter mounted on a hook to form an improved lure assembly, according to one embodiment of the present invention;

FIG. 3A is a perspective view illustrating an improved lure assembly comprising a lure and a reversible diverter mounted on the lure and being shown in an open position, wherein the lure is an artificial fly;

FIG. 3B is perspective view of the lure assembly of FIG. 3A, wherein the diverter is in a closed, streamlined position;

FIG. 4A illustrates a side view of a lure assembly comprising a reversible diverter mounted on a lure comprising an artificial lure body having hooks connected thereto, wherein the reversible diverter is shown in an open position, a closed position being illustrated in phantom lines (such phantom lines are similarly shown in FIGS. 4B-4E to illustrate possible closed positions);

FIG. 4B is a side view of an alternative embodiment of an improved lure assembly, the lure assembly comprising a reversible diverter mounted on a lure comprising: (i) a tube; and (ii) a hook, wherein the tube is mounted on the hook;

FIG. 4C is a side view of a lure assembly comprising a reversible diverter mounted on a lure comprising a wire and a pair of hooks mounted thereon;

FIG. 4D illustrates an exemplary embodiment of a lure assembly comprising a reversible diverter mounted on a lure comprising: (i) a hook; and (ii) a lure body mounted on the hook;

FIG. 4E is a side view of an alternative embodiment of a lure assembly comprising a lure and a diverter integrally extending from lure, wherein the diverter comprises a reversible cup directly mounted on a lure body of the lure;

FIG. 5A is a perspective view of an irregular reversible diverter, comprising a slanted cup, according to an alternative embodiment of the present invention;

FIG. 5B is a cross-sectional view of the reversible diverter illustrated in FIG. 5A;

FIG. 6A is a perspective view of a perforated reversible diverter, according to still another embodiment of the present invention;

FIG. 6B is a cross-sectional view of the perforated reversible diverter in FIG. 6A;

FIG. 7A is a perspective view of a notched reversible diverter, according to yet another embodiment of the present invention;

FIG. 7B is a cross-sectional view of the notched reversible diverter in FIG. 7A;

FIG. 8A is a front view of a reversible diverter having a circular cup, according to one embodiment of the present invention;

FIG. 8B is a front view of a reversible diverter having an oval cup with corresponding major and minor axes;

FIG. 8C is a front view of a reversible diverter illustrating a triangle-shaped cup;

FIG. 8D is a front view of a diverter having a square cup, according to another exemplary embodiment of the present invention;

FIG. 8E is a front view of an diverter having a vertically elongate, hexagonal cup, according to another exemplary embodiment of the present invention; and

FIG. 8F is a perspective view of the diverter illustrated in FIG. 8E.

### DETAILED DESCRIPTION OF THE PREFERRED EMBODIMENTS

The invention relates to a reversible diverter for use with fishing lures. The invention further relates to a reversible diverter for use with fishing lures that may be adapted by the user to allow a single lure to be used in a variety of different manners. For example, the reversible diverter may change the motion or appearance of a lure. In an exemplary embodiment, the reversible diverter comprises a sleeve and a cup connected to and in communication with the sleeve. The configuration of the sleeve and the cup enable an angler to use a lure in a number of different manners.

In one embodiment, the sleeve allows a user to mount the reversible diverter on a lure, thereby forming an improved lure assembly. The sleeve is configured to be mounted on a lure, directly or indirectly, such that a user can quickly and effectively couple the reversible diverter to the lure. The cup is configured to change the motion and/or appearance of a lure with minimal effort by the user. The cup allows a user to selectively configure the lure. In addition, the sleeve and/or cup can be proportionately sized to accommodate different sizes of hooks and lures. As such, a variety of types, sizes, and configurations of reversible diverters for lures may be used by utilizing the present invention.

Reference will now be made to the drawings to describe various aspects of exemplary embodiments of the invention. In the following description, numerous specific details are set forth in order to provide a thorough understanding of the present invention. It will be obvious, however, to one of ordinary skill in the art that the present invention may be practiced without these specific details.

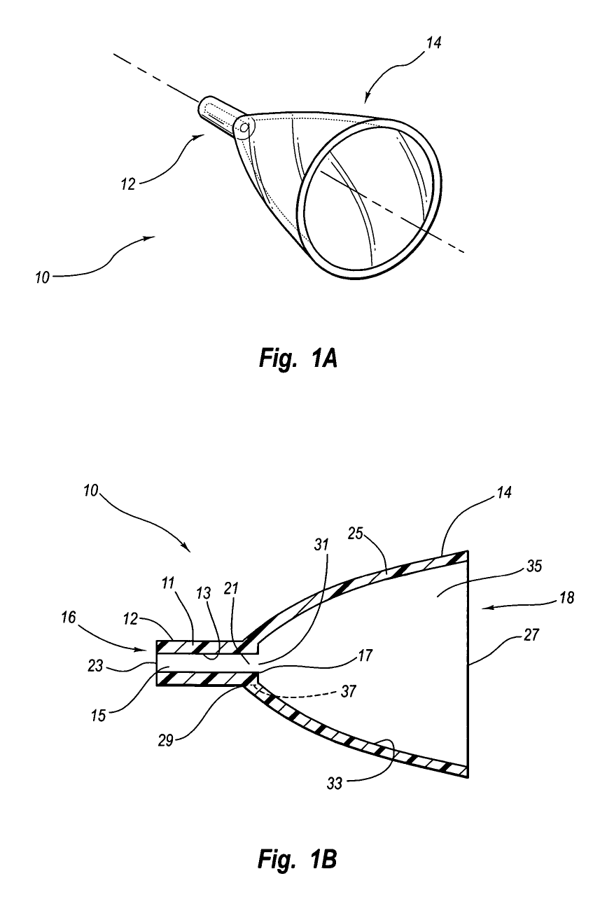

FIGS. 1A and 1B illustrate views of an exemplary reversible diverter 10 according to one embodiment of the present invention. Reversible diverter 10 comprises a sleeve 12 which is integrally coupled to a cup 14. Sleeve 12 may be mounted on a lure, thereby forming an improved lure assembly. Cup 14 can be placed in any of multiple positions, e.g., by reversing the direction of cup 14, so as to provide an angler a convenient way to alter the movement of a lure in the water, or to alter the appearance of a lure.

Sleeve 12 is comprised of a hollow, elongate, cylindrical tubular wall 11 having interior surface 13 that defines interior passageway 15. Sleeve 12 has a proximal end 17 having a proximal opening 21 therein and a distal end 16 having an opening 23 therein. Distal end 16 of sleeve 12 is also the distal end of the overall reversible diverter 10. Interior surface 13 extends between proximal end 17 of sleeve 12 and distal end 16 of sleeve 12.

Cup 14 is comprised of a bell-shaped, hollow, tubular wall 25 having a proximal end 18 having an opening 27 therein, and a distal end 29 having an opening 31 therein. In the embodiment illustrated in FIG. 1B, a junction 37 is formed at the interface between sleeve 12 and cup 14, and is represented by the phantom line. Cup 14 has an interior surface 33 that extends between proximal end 18 and junction 37, and defines an interior passageway 35. Junction 37 is formed in the interface between cylindrical wall 11 of sleeve 12 and bell-shaped wall 29 of cup 14.

In this embodiment, tubular wall 25 of cup 14 extends integrally from wall 11 of sleeve 12, such that cup 14 is integrally coupled to sleeve 12 and such that interior passageway 15 of sleeve 12 communicates with interior passageway 35 of cup 14. A feature of sleeve 12 having interior passageway 15 in communication with interior passageway 35 of cup 14 is that a lure can be inserted into sleeve 12, thereby allowing reversible diverter 10 to be quickly and easily be mounted on the lure to form an improved lure assembly. Consequently, as the lure passes through interior passageway 15 of sleeve 12, it can further be passed into interior passageway 35 of cup 14, and vice versa.

In the illustrated embodiment of FIGS. 1A-1B, cup 14 is convex with respect to sleeve 12. In this convex configuration of FIGS. 1A-1B, cup 14 is open, such that the diameter of cup 14 becomes greater as cup 14 extends away from a junction 37 between cup 14 and sleeve 12. Accordingly, the diameter of proximal opening 27 is greater than the diameter of distal opening 31, which is positioned adjacent junction 37.

In this exemplary embodiment, cup 14 is bell-shaped when open. A bell-shaped cup is advantageous for many reasons. For example, when reversible diverter 10 is mounted on a lure, water can enter through proximal opening 27 into cup 14. As water enters cup 14, the water presses against interior surface 33, thereby creating pressure forces which, in turn, produce added motion by a lure assembly. The movement of cup 14 through the water deflects the flow of water away from the lure, thereby disrupting laminar flow and creating turbulence which produces further movement by the lure mounted thereto. In some embodiments, the bell-shape of cup 14 of reversible diverter 10 produces an oscillating motion which imitates the natural motion of a minnow or other bait fish or otherwise stimulates the natural striking instincts of a predator fish.

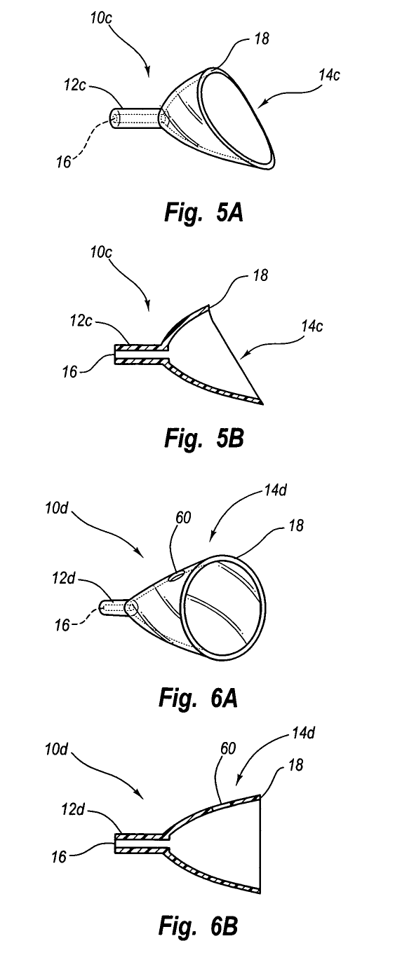

The illustrated reversible diverter 10 shows a cup 10 with a substantially parabolic bell-shape. However, it should be apparent that various shapes of cup 14 may be used and are within the scope of the present invention. In other embodiments, for example, cup 14 may be frusta-conical, or cup 14 may have ribs or have other shapes (e.g., see FIGS. 5A-8F). Also in the illustrated embodiment of FIGS. 1A-1B, the length of bell-shaped cup 14 is greater than the length of sleeve 12. Such a length of cup 14 allows reversible diverter 10 to extend in front of a lure and produce motion and action by a lure assembly. In some embodiments, the length of cup 14 is between about two to about ten times greater than sleeve 12. Accordingly, the length of cup 14 can be about two, three, four, or five times greater than the length of sleeve 12, for example. It will be appreciated, however, that the respective lengths of cup 14 and sleeve 12, and the relationship therebetween, can be varied.

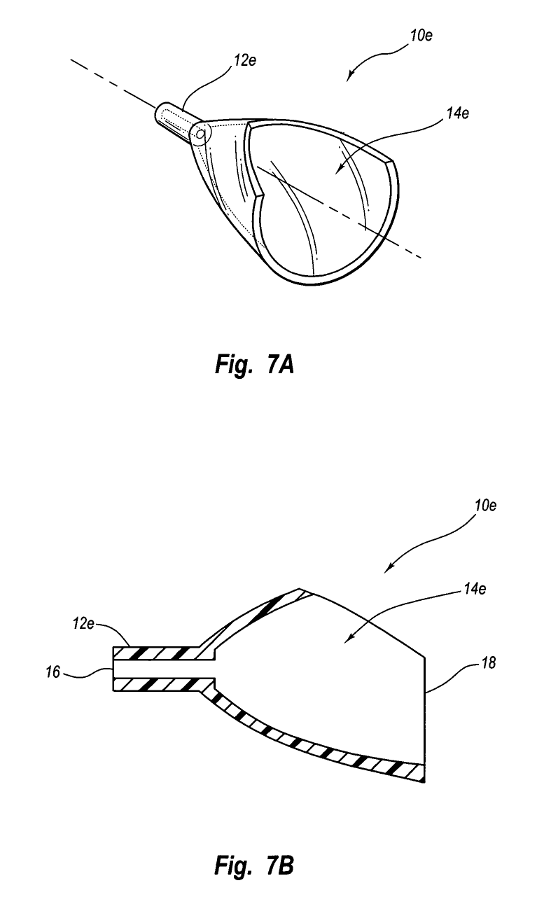

Wall 11 of sleeve 12 and wall 25 of cup 14 can be fabricated with substantially constant thicknesses. Additionally, the thickness of wall 11 can also be about equal to the thickness of wall 25. However, these features with respect to the respective thicknesses are not limiting. In particular, it is contemplated that the thickness of wall 25 of cup 14 can be greater or less than the thickness of wall 11 of sleeve 12. In still other embodiments, the thicknesses of sleeve 12 and/or cup 14 vary along their respective lengths (e.g., see FIG. 7B).

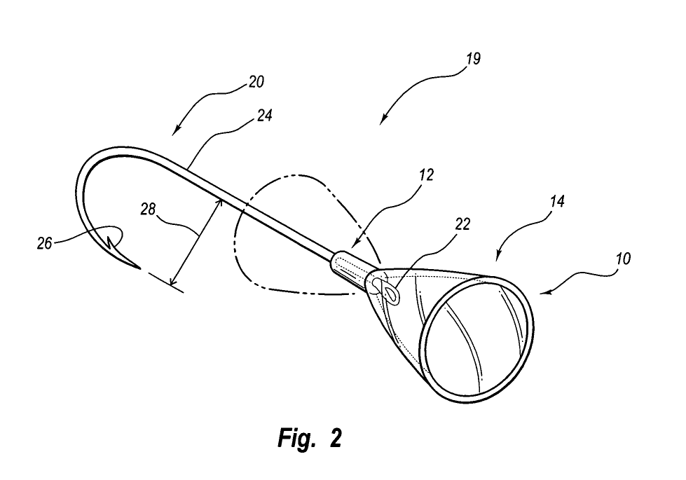

FIG. 2 illustrates an exemplary improved lure assembly 19 comprising reversible diverter 10 and lure 20. In the illustrated embodiment, lure 20 is a hook and comprises a hook eye 22, a hook shank 24, and a barb 26. Lure 20 is exemplary of a variety of types of lures which may be used with the present invention, and lure 20 may be used in any of a variety of ways or for any number of applications. For example, lure 20 can be attached to a lure body, or can be used as the base for an artificial fly, or it can receive a worm, salmon eggs, squid, or other type of natural or artificial bait. It will also be appreciated that lure 20 is merely one type of lure which is representative of many configurations of lures which are available. For example, a lure of the present invention may comprise a hook having one, two, or three or more barbs, for example, and may have and/or one or more objects mounted on the hook, such as a tube attached to the shank of the hook, fly tying materials, a lure body, or other objects mounted on the hook.

Sleeve 12 is configured to be mounted on at least a portion of lure 20. For example, in the illustrated embodiment, sleeve 12 is directly mounted on hook shank 24 of lure 20. In directly mounting sleeve 12 in this manner, internal passageway 15 of sleeve 12 receives and passes over hook eye 22 and/or barb 26 and is moved to the illustrated position on hook shank 24. In some implementations, the diameter of internal passageway 15 of sleeve 12 is smaller than the outer diameter of hook eye 22, barb 26, and/or the diameter of hook shank 24. Accordingly, to receive a portion of lure 20 despite the smaller internal diameter, sleeve 12 can be fabricated from a flexible material. A flexible sleeve 12 has internal surface 13 which expands as sleeve 12 slides over lure 20. When expanded, sleeve 12 frictionally engages lure 20, thereby creating a frictional fit between reversible diverter 10 and lure 20. This frictional engagement occurs as between interior surface 13 of sleeve 12 and lure 20 as sleeve 12 slides over a portion of lure 20. It will be appreciated, however, that this feature is not necessarily limiting. For example, in another embodiment, sleeve 12 is mounted on lure 20 such that sleeve 12 is molded on, or otherwise integrally extends from, lure 20.

Lures such as the illustrated hook are available in numerous different sizes and configurations. Naturally, a larger hook is generally used to hold large bait and/or to catch larger fish. An additional feature of sleeve 12 made from flexible material is that sleeve 12 can fit over various sizes and configurations of lures. The use of flexible material to accommodate various sizes of lures is not a limiting feature, however. For example, in other embodiments, sleeve 12 is not flexible and does not stretch to accommodate larger sizes and widths of lures. It will also be appreciated that whether sleeve 12 is made of flexible or non-flexible material, reversible diverters can be fabricated in various sizes to accommodate different sizes and configurations of lures.

As noted, sleeve 12 is configured to be mounted on lure 20. After sleeve 12 is positioned around a desired portion of lure 20, sleeve 12 can then be secured in place, thereby also securing reversible diverter 10 to lure 20 and forming lure assembly 19. In one embodiment, a frictional, interference fit between sleeve 12 and lure 20 securely mounts reversible diverter 10 on lure 20. Although the foregoing description details slipping sleeve 12 over hook eye 22 and hook shank 24 to mount reversible diverter 10 on lure 20, this is exemplary only and one skilled in the art will appreciate that other methods of mounting reversible diverter 10 are within the scope of the present invention. For example, sleeve 12 may be slipped past barb 26 and onto hook shank 24. In yet another embodiment, cup 14 may first receive eye 22 and/or hook shank 26.

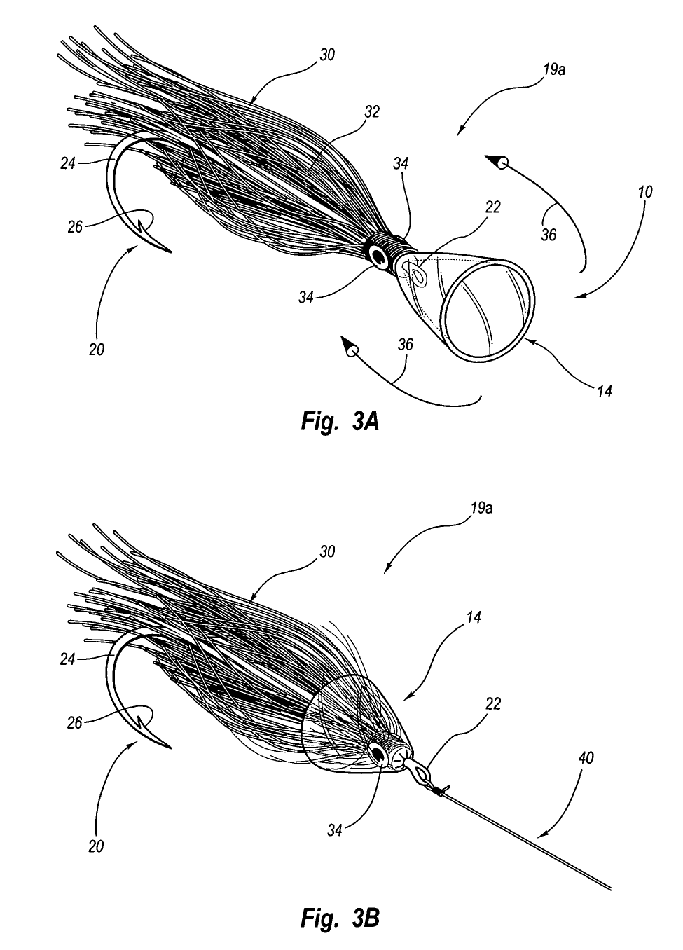

In another embodiment, such as is shown in FIGS. 3A and 3B, sleeve 12 is tied into place. For instance, when a lure of the present invention comprises an artificial fly, the fly tier can wrap thread or floss around sleeve 12 to securely mount sleeve 12 onto the lure. Alternatively, a glue or adhesive may be used to securely mount sleeve 12 on lure 20.

In the illustrated embodiment of FIG. 2, cup 14 of reversible diverter 10 is open and positioned so as to enclose a portion of, and extend past, hook eye 22 and lure 20. In this manner, proximal opening 27 is not positioned directly over lure 20. Sleeve 12 extends in an opposite direction, along hook shank 24. Thus, proximal end 18 of cup 14 is opposite sleeve 12. In this open, frontal configuration, cup 14 is convex with respect to sleeve 12. In some embodiments, this frontal, open, convex position defines a first position of cup 14 and/or reversible diverter 10.

Reversible diverter 10 is configured to create motion on lure 20 when cup 14 is in this open position. As open reversible diverter 10 and lure 20 are moved through water, reversible diverter 10 disrupts and prevents the smooth, streamlined flow of water around lure 20. Because cup 14 is positioned in front of lure 20, water first flows into cup 14 and creates forces which create resistance to the forward motion of lure assembly 19. These resistance forces push against interior surface 33 of cup 14 and the flowing water is also displaced and disrupted from a typical, streamlined flow around lure 20. As previously noted, this displacement creates turbulence around lure 20. This combination of forces disrupts the streamlined flow of water and, in turn, produces motion and action by lure 20 which is not created without reversible diverter 10 mounted on lure 20.

In general, certain bait fish swim by moving their tail fins side-to-side. To stimulate the natural attack instincts of fish which prey on bait fish, anglers have attempted, with marginal success, to simulate this natural, side-to-side motion. For example, a fly fisherman may strip the line or move the tip of the rod in an attempt to create this side-to-side motion. However, because the angler acts remotely from the lure, it is difficult to control and sustain the motion. Accordingly, strip action and rod action rarely produce a natural looking motion by the lure.

In the exemplary embodiment, reversible diverter 10 is configured to produce an oscillating side-to-side or up-and-down motion when lure assembly 19 is moved through the water. Naturally, as lure assembly 19 undulates, any attached bait or other lure components also have corresponding motions. This motion is particularly effective and desirable when lure assembly 19 resembles or imitates the natural prey of a fish. Accordingly, a feature of reversible diverter 10 is a first position that it induces a natural, fish-like motion in lure assembly 19.

While reversible diverter 10 can act as an alternative to strip and/or rod action, it can also be used in connection with these actions. For example, by combining strip or rod action with reversible diverter 10, the intensity, amplitude, and/or frequency of the oscillating motion by lure assembly 19 can be increased. As such, the appearance of the motion in lure assembly 19 and any bait attached thereto can be made to be even more life-like, or can be used to create an illusion that prey is tying to escape from a predator fish. Reversible diverter 10 can, itself, also be configured to vary the amplitude and/or frequency of the natural, side-to-side motion on lure assembly 19 to imitate bait fish of varying speeds. In one embodiment, the amplitude of the oscillating movement is greater as the width of cup 14 increases. However, the larger amplitude can also decrease the frequency of the back-and-forth, side-to-side or up-and-down motion, thus giving the appearance of a slow swimming bait fish. Alternatively, reductions in the width of cup 14 can allow imitation of faster bait fish by increasing the frequency of the oscillating movement and decreasing the amplitude.

In the illustrated embodiment of lure assembly 19, lure 20 is a hook that can be used with bait, an artificial lure body, or an artificial fly. To allow lure 20 to receive a fly, lure body, or bait, reversible diverter 10 does not interfere with the placement of the bait, lure body, or fly, and does not substantially alter the appearance thereof. Sleeve 12 receives only a portion of hook shank 24, such that at least a significant portion of hook shank 24 may still be used for attaching bait, lure body, or fly tying components. Sleeve 12 also, in some embodiments, has an external diameter that is sufficiently small to allow a fly to be tied directly over sleeve 12, or to allow bait, a lure body, or another object to be positioned over sleeve 12.

Additionally, when sleeve 12 of reversible diverter 10 is placed adjacent the hook eye 22 as shown in FIG. 2, reversible diverter 10 does not reduce the hook gap 28 of lure assembly 19, thereby also avoiding interference with effectiveness of lure assembly 19. Hook gap 28 is the distance from hook shank 24 to barb 26. The hook gap 28 can be important to anglers because, in general, a larger distance defining the hook gap provides more room for a fish's mouth between shank 24 and barb 26, thus increasing the percentage of hook-ups when a fish bites. Where bait or a fly is placed between hook shank 26 and the point of barb 26, hook gap 28, and the efficiency of lure 20, can be reduced. As illustrated in FIG. 2, sleeve 12 is mounted on lure 20. In one embodiment, such as that illustrated, junction 37 is positioned adjacent hook eye 22, such that sleeve 12 extends along hook shank 24, and cup substantially extends over, and beyond, hook eye 22. Accordingly, in this embodiment, reversible diverter 10 does not extend along all or substantially all of hook shank 24, and does not interfere with or reduce hook gap 28. In this embodiment, when cup 14 is in the frontal, open position, neither cup 14 nor sleeve 12 reduces hook gap 28. As a result, reversible diverter 10 can be used to, in part, increase the movement by lure assembly 19 without adversely affecting hook gap 28.

FIGS. 3A and 3B provide perspective views of an exemplary embodiment of a lure assembly 19a in which reversible diverter 10 is mounted on a lure 30. In FIG. 3A, reversible diverter 10 is in a frontal, open position, and mounted on lure 30. Additionally, in this exemplary embodiment, cup 14 is selectively positioned in the frontal position, such that cup 14 is convex and positioned in front of lure 30 and sleeve 12 as reversible diverter 10 is securely mounted on lure 30. As previously noted, this frontal position has many advantages, including the inducement of a side-to-side or other motion which is easier to implement, and/or more natural than motion created either by strip or rod action.

Lure assembly 19a comprises a lure 30 and a reversible diverter 10. Lure 30 comprises a hook 20 and fly tying components 32 secured to hook 20 and/or secured to reversible diverter 10. In one embodiment, fly tying components 32 are secured only to reversible diverter 10, while in another embodiment, fly tying components 32 are secured only to hook 20. In still another embodiment, fly tying components 32 are secured to hook 20 and to reversible diverter 10.

Any of a number of materials may be used as fly tying components 32. For example, fur, hair, feathers, hackle, string, thread, beads, etc. are representative of the types of fly tying materials which are commonly used in creating artificial flies, and which may also be used as fly tying components 32. To imitate the appearance of natural insects or fish, an eye is also commonly added to artificial flies. Accordingly, lure 30 also has a fly eye 34 secured thereto. In the illustrated embodiment, fly eye 34 is secured to lure 30 near hook eye 22. Additionally, while the illustration depicts fly tying components 32 positioned, e.g. tied, about the exterior surface of wall 11 of sleeve 12, it will be appreciated by a person having ordinary skill in the art that this embodiment is exemplary only. In some embodiments, it is contemplated that fly tying components 32 are first secured to hook shank 24 to form a lure 30, and that interior surface 13 of sleeve 12 is positioned over, or otherwise contacts, fly tying components 32, or that reversible diverter 10 is mounted on a previously tied artificial fly.

In the illustrated embodiment, cup 14 receives hook eye 22 of lure 30 when cup 14 is in the open position (See FIG. 3A). In this embodiment, hook eye 22 is entirely within interior passageway 35 of cup 14. When cup 14 is reversed, hook eye 22 may not be within cup 14 (e.g., see FIG. 3B). Reversible diverter 10 is further configured to permit fishing line to be attached to lure assembly 19a. For instance, in the illustrated embodiment, proximal opening 27 makes cup 14 open to ambient, thus allowing an angler access to hook eye 22 which is positioned within interior passageway 35. Accordingly, an angler may access hook eye 22 through open cup 14, and connect fishing line to lure 30.

Once an angler has landed a fish, the fish will generally begin to fight the angler and try to slip the hook by pulling against the angler's reeling motion. When the fishing line is at least partially received by is within cup 14, this fighting motion increases the likelihood that the fishing line will press up against interior surface 33 of cup 14. Particularly when the contact is caused by a fighting fish, the line can be pressed against interior surface 33 of cup 14. Accordingly, cup 14 can be adapted to reduce the risk that such contact will fray or break the fishing line. For example, as previously discussed, sleeve 12 can be fabricated from a soft, flexible material. Cup 14 can also be made from a similar, soft material. The soft material allows cup 14 to flex when in contact with the fishing line, thus absorbing the forces exerted by the line on cup 14, and reducing the resistance that otherwise could result in fraying.

As discussed above, cup 14 can further be configured to be selectively positionable. For example, where cup 14 comprises a flexible material, cup 14 can be selectively moved from a first position, such as the open position illustrated in FIG. 3A, to a second position, and then back to the first position if desired. In one embodiment, cup 14 is reversed by applying pressure (e.g. manual pressure) to proximal end 18 of cup 14, substantially in the direction of arrows 36, thereby resulting in the selective movement of cup 14 to a rear, closed position such as that illustrated in FIG. 3B. The illustrated rear, closed position of FIG. 3B, is one embodiment of a second position of cup 14 and reversible diverter 10 on a lure assembly 19a. Pressure (e.g. manual pressure) can then be used to return cup 14 to the open position, if desired. As will be appreciated, cup 14 can also be moved to other positions. For example, intermediate positions can exist between the illustrated frontal and rear positions of cup 14. Optionally, cup 14 can be configured to be rigid, such that it is not selectively positionable, but rather is either in a permanently open or closed position.

In the illustrated closed position of FIG. 3B, cup 14 is concave with respect to sleeve 12. In this concave, closed, streamlined position, proximal end 18 of reversible diverter 10 is folded over a portion of hook shank 24 and sleeve 12, such that interior passageway 35 of cup 14 is positioned around, and can contact, fly tying components 32. In this embodiment, the length of cup 14 is greater than the length of sleeve 12. Accordingly, when cup 14 is in the rear position, proximal end 18 extends further along hook shank 24 and lure 30 than does sleeve 12. Thus, proximal end 18 extends further than distal end 16 along lure 30. In other embodiments, however, sleeve 12 can be longer than cup 14 or proximal end 18 may not extend beyond distal end 16. In still other embodiments, cup 14 may be configured to only partially reverse such that proximal end 18 does not extend past distal end 16 and/or such that cup 14 is partially concave and partially convex.

Reversible diverter 10 is also configured for an angler to quickly and effectively change the positions of reversible diverter 10, thereby quickly and efficiently changing the configuration of lure assembly 19a. As noted previously, sleeve 12 can receive a lure or otherwise be mounted thereon. When an angler desires to reposition reversible diverter 10, the angler may simply apply pressure either along or against arrows 36, thereby selectively pushing or pulling cup 14. It is also desirable that sleeve 12 not slip as cup 14 is selectively pushed or pulled. One way in which this can be accomplished is to securing sleeve 12 to lure 30 in any manner previously mentioned (e.g. compression fit, adhesive or thread).

Fabricating cup 14 from a flexible material can facilitate the selective positioning and/or reversal of cup 14 and reversible diverter 10. However, and as previously noted, where cup 14 is selectively positioned in an open position, water flows into cup 14 and creates resistance which tends to push against cup 14 in the direction of arrows 36. As a result, the resistance increases the likelihood that cup 14 will be inadvertently reversed by the water when in use, thereby also reducing the ability of the angler to selectively configure lure assembly 19 for its most effective use. Therefore, in some embodiments, reversible diverter 10 is adapted to be resistant to inadvertent repositioning and/or reversal of cup 14.

In one embodiment, material selection is used to reduce the risk of underwater reversal of reversible diverter 10 and reconfiguration of lure assembly 19a. For example, the flexible material used to make cup 14 can be a plastic material which is flexible yet resistant to inadvertent inversion. Such a material can be sufficiently flexible to allow an angler to, with sufficient force, manually invert reversible diverter 10, yet also provide resistance that counteracts the forces applied by the flowing water. For instance, in some embodiments, cup 14 comprises (e.g. is molded, such as through injection or insertion molding) ethylene-vinyl-acetate copolymer (EVA), which balances flexibility and strength so as to favor manual repositioning of reversible diverter 10, thereby also reducing the chance of accidental or inadvertent reconfiguration of lure assembly 19a. In other embodiments, liquid silicon or latex rubber is used to form reversible diverter 10. In one embodiment, the material forming reversible diverter 10 comprises EVA having a vinyl acetate content between about twenty-six and about twenty-eight percent, and having a vicat softening point at about forty degrees Centigrade. The type of material employed can also vary depending upon the water temperature that the diverter is to be used in. As will be appreciated by a person having ordinary skill in the art, other methods may also be used to avoid inadvertent reversal. For example, in some embodiments, the thickness of the portion of tubular wall 25 which is adjacent distal end 29 of cup 14 can be adapted for this purpose.

As will be appreciated by a person having ordinary skill in the art, other methods may also be used to avoid inadvertent reversal when underwater. For example, in some embodiments, the thickness of tubular wall 25 of cup 14 can be adapted to prevent inadvertent reversal, while still enabling reversal when desired and/or selected by the angler.

For many reasons, it is desirable that reversible diverter 10 be adapted to have a plurality of selectable positions. For example, reversible diverter 10 is, in this embodiment, configured to allow for efficient securement of lure 30 and lure assembly 19a to line 40. When cup 14 is in a first position (see, e.g. FIG. 3A), cup 14 may cover all or a portion of hook eye 22. In such a position, and with some configurations of cup 14, it may be difficult to access eye 22 when attempting to thread line 40 through hook eye 22, or to otherwise couple line 40 to lure 30. By moving cup 14 to a second position, such as the rear position illustrated in FIG. 3B, cup 14 may no longer cover hook eye 22, thereby making hook eye 22 more accessible and allowing an angler to more efficiently couple line 40 to lure assembly 19a. As a result, in at least one position, reversible diverter 10 facilitates securement of line 40 to lure assembly 19 and lure 30.

Notably, reversible diverter 10 also allows an angler to selectively determine the swimming action of lure assembly 19a. In an exemplary embodiment, and as previously discussed with respect to FIGS. 2 and 3A, cup 14 can be positioned in a frontal position which gives lure 30 an oscillating motion which mimics the natural motion of bait. When reversible diverter 10 is moved to a second position, such as the rear, closed position in FIG. 3B, this motion may be selectively altered. For instance, in FIG. 3B, reversible diverter 10 conforms somewhat to the shape of lure 30. As such, the profile shape of lure 30 with reversible diverter 10 in a closed position streamlines the flow of water around lure assembly 19a. Where reversible diverter 10 is in the rear position, lure assembly 19 can have a swimming motion that does not have an induced side-to-side or other oscillating motion.

In one example, lure 30 is an artificial fly known as a streamer that imitates the appearance of a bait fish, and is streamlined to glide under the water with minimal side-to-side motion. In a first, frontal position, lure assembly 19a imitates the natural motion of the imitated bait fish. Alternatively, if an angler positions reversible diverter 10 in a rear position, lure assembly 19a can be adapted to substantially maintain the gliding motion natural to a streamer, or to otherwise streamline flow around the lure assembly 19a. As a result, in this exemplary embodiment, lure assembly 19a has multiple actions that can be selectively determined by selectively changing the position of reversible diverter 10.

A multi-action lure has many advantages. Many anglers are limited in the number of lures which they have available at any given time; however, reversible diverter 10 can effectively give an angler at least twice the number of options without an increase in the number of lures to carry. Generally, lures have a single appearance and/or associated swimming motion when used. By mounting reversible diverter 10 on a lure, the motion of the lure can be selectively varied. As noted, this motion may, in exemplary embodiments, varied between a streamlined and/or natural motion of the lure, and an oscillating or random motion configured to mimic a life bait fish. In this manner, when a lure assembly isn't effective in one configuration, the angler may simply re-position reversible diverter 10 to give the lure assembly a different action, and thus a different appeal to a predator fish.

Reversible diverter 10 also provides advantages to the angler who isn't significantly limited in the number of lures available. Fishing conditions change with the time of day, temperature, humidity, storminess, etc. Frequently, when the conditions change, there is also a change in lures are effective. Sometimes, conditions change quickly and it is desirable for an angler to be able to quickly and easily change to a new lure to take advantage of the altered conditions. To adjust to the new conditions, an angler generally must remove the existing lure, and add a new lure. In some cases, this requires that the angler cut and/or re-tie the line to the new lure. In either case, this takes away valuable fishing time. By using a reversible diverter on a lure assembly, an angler may change the position of reversible diverter and reconfigure the lure assembly to meet changing conditions, without removing the lure assembly from the fishing line. As noted, this may be as simple as pulling or pushing on the reversible diverter to reposition the reversible diverter, and which can take only seconds or fractions of seconds. This quick change alters the motion of the lure assembly, without any significant, adverse impact on the fishing time available to the angler.

With continued reference to FIG. 3B, reversible diverter 10 can also be configured to protect at least a portion of lure 30 comprising fly tying components 32. In tying artificial flies, fly tying components 32 are frequently attached to hook 20 near hook eye 22. It is often important to protect the point at which fly tying components 32 are tied to hook 20, because, when the tie-in point is damaged, fly tying components 32 can undesirably fall off lure 30, thereby changing the appearance of lure 30. This damage may occur as lure 30 impacts the water, when a fish bites lure 30, or if lure 30 hits the fishing rod. To protect the tie-in point, an angler will often apply epoxy, cement, or silicon to the head of an artificial fly. These substances may be applied in a liquid form, and allowed to dry or cure to form a hard exterior that protects the tie-in point.

In the illustrated embodiment of FIG. 3B, reversible diverter 10 is positioned in a rear, closed position, such that it covers the portions of lure 30 adjacent hook eye 22. In this manner, cup 14 of reversible diverter 10 is positioned over, and covers the tie-in point, and can thus replace and/or supplement an epoxy, cement, silicon, or other protective device or material. When in this position, an impact against lure 30 is received by cup 14, rather than directly by the tie-in point. Particularly where cup 14 is made from a flexible material, cup 14 can distribute the impact throughout reversible diverter 10, thus reducing the impact—and corresponding damage—to the tie-in point. The use of reversible diverter 10 to protect the tie-in point of lure 30 can also realize advantages over other protection materials. For example, reversible diverter 10 can be tied to or frictionally mounted on lure 30, thus eliminating the mess and cleanup involved in applying a cement, epoxy, or silicon. Additionally, once reversible diverter 10 is mounted, lure assembly 19a can be used without waiting for an epoxy, cement, or silicon to dry and/or cure. It will also be appreciated that the tie-in point may be positioned under sleeve 12 (e.g., where sleeve 12 is positioned over a previously tied fly) or on top of sleeve 12 (e.g., where sleeve 12 is mounted directly on a hook and fly tying materials are tied over sleeve 12).

Further, other substances can add significant weight to the front of lure 30. In some cases, the added weight is desirable because it can cause lure 30 to dive down. Diving down may be desired where, for example, fish are located at greater depths. However, it is not always desirable that a lure dive down (such as where the fish are feeding at or near the surface). Reversible diverter 10 can be made of a lightweight material. Accordingly, reversible diverter 10 can avoid a significant increase to the weight of lure 30. In another embodiment, reversible diverter 10 is made lightweight by controlling the thicknesses of wall 11 and wall 25.

A lightweight diverter further features the advantage of reducing the need for an angler to alter the cast to adjust for the added weight. When weight is added to lure assembly 19a, the angler must modify the cast so as to cast lure assembly 19a to a desired location. However, where reversible diverter 10 is lightweight, the necessary modifications to the cast are reduced as compared with an epoxy, cement, silicon, or the like.

Still another advantage of a flexible reversible diverter 10 is contemplated in exemplary embodiments of the present invention. The flexible material can give the frontal portion of a lure a softer feel than is obtained with an epoxy or cement. As such, if reversible diverter 10 hits the fishing rod, it is unlikely to damage either the rod or flexible diverter 10. In contrast, hardened epoxy or cement may damage the rod, or the material itself may crack when hit against the rod or other objects, thus reducing its effectiveness.

Additionally, flexible reversible diverter 10 may, as illustrated in FIG. 3B, substantially conform to the shape of lure 30. As such, reversible diverter 10 creates little to no reduction in hook gap 28, even when in a rear position. In still another embodiment, reversible diverter 10 is configured to substantially maintain the appearance of a lure such as lure 30. For example, in the illustrated embodiment, reversible diverter 10 is light permeable (e.g. made from a transparent or translucent material). In such an embodiment employing a light permeable material, e.g. a transparent plastic material, when positioned in the illustrated rear position of FIG. 3B, fly tying components 32 and fly eye 34 are visible though cup 14. Thus, the original appearance of lure 30 is substantially maintained whether reversible diverter 10 is positioned in a first or second position. In an alternative embodiment, reversible diverter 10 is an opaque, colored material, or has other designs therein. Such a configuration of reversible diverter 10 also features various advantages. For example, cup 14 can alter the appearance of lure 30. As such, the utility of lure assembly 19a can further be increased as a first position can alter motion, while a second position can change motion and/or appearance of lure 30. In some embodiments, one or more eyes may be painted on, or otherwise secured to, reversible diverter 10. In this manner, when reversible diverter 10 is opaque or when there is not an eye on a lure, it may imitate bait having eyes.

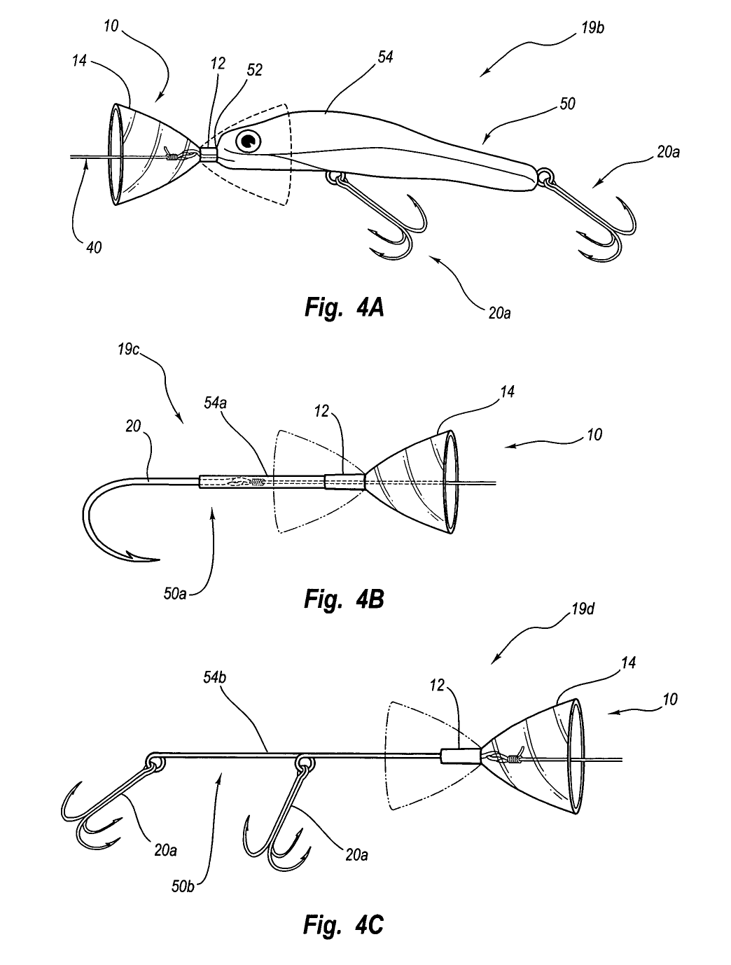

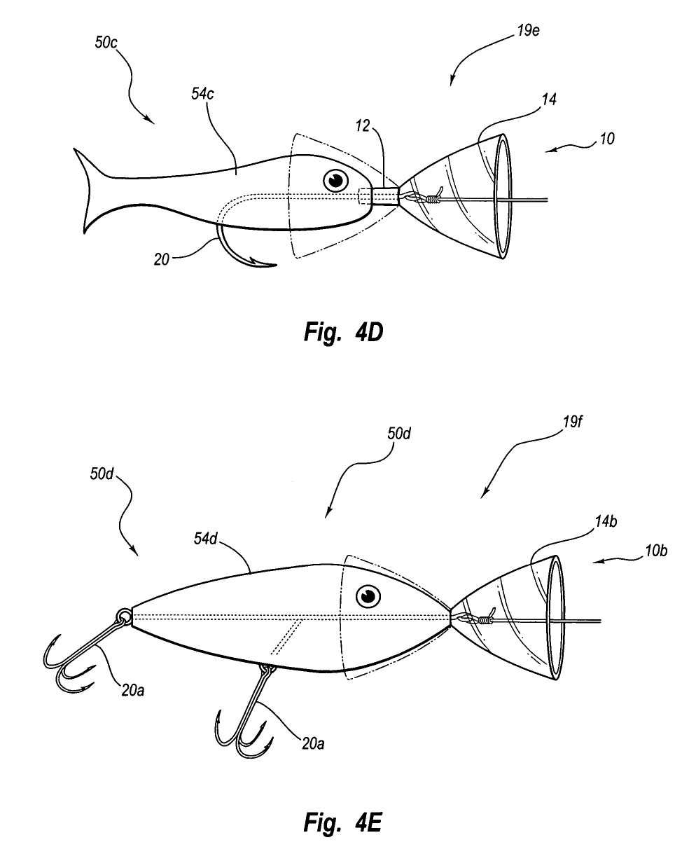

FIG. 4A illustrates an exemplary embodiment an alternative lure assembly 19b having a reversible diverter 10 mounted on a lure 50. As illustrated, lure 50 can comprise a body 54 and a plurality of hooks 20a connected to body 54 of lure 50. It will be appreciated, however, that the illustrated lure 50 is merely representative of the wide variety of fishing lures with which reversible diverter 10 may be used (see, e.g. FIGS. 2-3B and 4B-4E). Accordingly, reversible diverter 10 can just as effectively be used where a lure comprises a hook, artificial fly, jig, artificial bait, spoon, spinner, etc.

In the illustrated embodiment, reversible diverter 10 slides over the hook eye, and is thereby mounted on head 52 of lure 50. In other embodiments, reversible diverter 10 can be mounted on lure 50 by being connected to or otherwise mounted on one or more of hooks 20a. Alternatively, reversible diverter 10 can be mounted on lure 50 by being molded in or otherwise integrally extending from lure body 54.

In still another alternative, reversible diverter 10 can be indirectly mounted on a lure. For instance, it is contemplated that another embodiment of a lure assembly comprises a diverter 10 placed on fishing line that is connected to a lure. In such an embodiment, sleeve 12 or diverter 10 can freely move along the fishing line or it can be tied in place, or secured or have its motion limited by a weight, stop, or other device limiting the movement of reversible diverter 10 along the fishing line. In still other alternative embodiments, the fishing line is secured to a lure and reversible diverter 10 is placed on the fishing line without a stop, such that it can move along the line and so as to contact the lure when pressed against the lure (e.g., by gravity or water pressure thereon), thereby mounting reversible diverter 10 on the lure. In such a configuration, reversible diverter 10 has freedom to move along the fishing line.

Thus, when reversible diverter 10 is connected to fishing line 40, either in or out of contact with a lure, reversible diverter 10 may still produce motion in a lure assembly. Accordingly, a lure assembly is formed when a diverter is used in conjunction with a lure. As described herein, a diverter can be used in conjunction with a lure when, for example, the diverter is directly mounted on a lure, or when a diverter is indirectly mounted on a lure, such as by slideably mounting a diverter on fishing line secured to a lure, or otherwise indirectly mounting the diverter on a lure.

When mounted on lure 50, or used in conjunction therewith, reversible diverter 10 can, in some embodiments, alter the motion and/or appearance of lure assembly 19b. For example, in the position illustrated by FIG. 4A, reversible diverter 10 can induce a natural, oscillating motion in lure assembly 19b. Alternatively, reversible diverter 10 can be moved to the closed position as represented by the phantom lines, and may streamline the motion of lure assembly 19b. Alternatively, the reversed position of reversible diverter 10 can change the appearance of lure assembly 19b.

Additionally, reversible diverter 10 can be mounted on lure 50 in any of numerous ways. For example, it is contemplated that reversible diverter 10 is mounted on head 52 of lure 50, e.g., removably mounted thereto by friction. Alternatively an adhesive, thread, interference fit and/or some other method can be used for removably or permanently mounting reversible diverter 10 on lure 50, either directly or indirectly. Head 52 can comprise a portion of lure body 54 that is contacted by sleeve 12 and/or a wire or tube extending from lure body 54, about which sleeve 12 extends, for example.

In FIG. 4B, lure assembly 19c includes a reversible diverter 10 mounted on a lure 50a. In this embodiment, lure 50a includes a lure body 54a attached to a hook 20. Lure body 54a is, in this embodiment, a hollow tube and can be fabricated from a plastic or metal. An exemplary use of lure body 54a made of a hollow tube is in connection with tube flies or with live, dead, or artificial bait. Line 40 may be secured to lure body 54a and/or to hook 20. As lure body 54a is hollow, line 40 can be passed into lure body 54a. Accordingly, line 40 can extend from a rod-and-reel combination to hook 20a, and be secured thereto, by running through the interior of lure body 54a. While the illustrated embodiment depicts lure body 54a as a hollow tube, and reversible diverter 10 being placed over and engaging lure body 54a, it will be appreciated that other embodiments are contemplated. For example, a solid or only partially hollow tube may be used as a lure body. In other embodiments, two or more tubes combine to form a lure body. In yet other embodiments, sleeve 12 can be molded in, or otherwise integrally extend from lure body 54a. For example, lure body 54a may be an extension of sleeve 12 and may have a diameter greater or less than the external diameter of sleeve 12. Lure body 54a can be affixed to hook 20 or can be freely movable along the fishing line that is attached to hook 20.

As illustrated in FIG. 4C, an improved lure assembly 19d is contemplated in which reversible diverter 10 is coupled to a lure 50b, and wherein lure 50b has a lure body 54b comprising a wire. A lure body 54b made from a wire such as that illustrated can be used in connection with any number of baits or lures. For example, in some embodiments, lure body 54b is enclosed within an artificial lure such as that illustrated in FIG. 4A, and/or makes up the head or eye of a lure. In other embodiments, lure assembly 19d is used without an additional artificial lure, and an angler connects one or more hooks 20a to lure body 54b. Any number of materials are suitable for fabrication of lure body 54b that is a wire. For example, representative materials include, but are not limited to: steel, stainless steel, aluminum, titanium, or the like. In still other embodiments, lure body 54b is fishing or leader line.

In the illustrated embodiment, hooks 20a are connected to the wire that forms lure body 54b. While the illustrated embodiment depicts the use of two hooks 20a on lure body 54b, it will be appreciated that more or less than two hooks may be connected to form lure assembly 19d. As illustrated, however, the wire forming lure body 54b acts as a means for mounting reversible diverter 10 on a plurality of hooks. It will also be appreciated that lure body 54b may be attached to any of various configurations of hooks. Representative types of hooks suitable for use with lure assembly 19d include, for example, treble hooks, bait hooks, jig hooks, double hooks, circle hooks, fly hooks, and worm hooks.

A reversible diverter can be permanently or releasably mounted on a lure. For example, in FIG. 4D, lure assembly 19e comprises a lure 50c with a reversible diverter 10a mounted thereon. In this embodiment, lure 50c includes a hook 20 penetrating, and extending through, at least a portion of lure body 54c. A variety of baits or other fishing elements can be used to make lure body 54c. For example, lure body 54 can be a minnow, sardine, or other bait fish. Alternatively, lure body 54c can be a flexible, plastic material which imitates the appearance of bait.

In this embodiment, reversible diverter 10 includes a hollow sleeve 12 attached to an open cup 14. Reversible diverter 10 can be a flexible plastic material. It is contemplated that reversible diverter 10 be either separate from, or integral with, lure body 54c. Accordingly, reversible diverter 10 and lure body 54c can be made from the same or different materials, and can be formed in a single or different mold or cast. Alternatively, where reversible diverter 10 and lure body 54c are separate, sleeve 12 can be mounted on hook 20 or to lure body 54c. In the illustrated embodiment of lure assembly 19e, sleeve 12 can also be positioned at least partially inside lure body 54c.

FIG. 4E illustrates a lure assembly 19f having an alternative embodiment of reversible diverter 10b comprising a cup 14b directly mounted on a lure body 50d. Reversible diverter 10b can be securely mounted on lure body 54d with an adhesive or other method. In this embodiment, for example, reversible diverter 10b comprises reversible cup 14b which integrally extends from lure body 54d. In the illustrated embodiment, cup 14b is directly mounted on lure body 54d, without having a sleeve attached to, or otherwise mounted on, cup 14b. It will be appreciated, however, that a sleeve can also be used and can integrally extend from lure body 54d. Further, a wire can run through lure body 54d and, as described with respect to FIG. 4B, can have one or more hooks 20a attached thereto. Alternatively, one or more hooks 20b can be directly attached to lure body 54d. In this manner, lure body 54d can also act as means for mounting reversible diverter 10b on a plurality of hooks. Cup 14b may have an aperture therein through which a hook or line and/or lure body portion may extend.

FIGS. 5A and 5B are alternate views illustrating still another exemplary embodiment of a reversible diverter. In this embodiment, reversible diverter 10c has a cup 14c which is slanted on proximal end 18. Unlike the cup 14 illustrated in FIG. 1, cup 14c is irregular in shape. The illustrated slanted cup 14c has only a single axis of symmetry. Additionally, the distance between proximal end 18 and distal end 16 of slanted cup 14c varies with a position of proximal end 18. The slant may be created by cutting a portion of symmetrical cup such as that illustrated in FIG. 1, or it can be molded to form the illustrated cup 14c. Where the slant is created by cutting cup 14c, it will be appreciated that one or more cuts can be used to create the slant.

In the illustrated embodiment, cup 14c has a straight slant which extends along the entire length of proximal end 18. Other irregular or slanted configurations of a cup are contemplated. For example, as illustrated in FIGS. 7A and 7B, cup 14e has a notch formed or cut therein. A notch or slant may be straight or curved (concave or convex), or a notch or slant can be varied such that there are more or less than one axis of symmetry on a cup. Although a single notch is illustrated in FIGS. 7A and 7B, it will also be appreciated that more than one notch may be made in cup 14e.

A slant or notch on proximal end 18 results in the respective cup having reduced symmetry when compared to the reversible diverter illustrated in FIG. 1A. As water flows into and over a symmetrical reversible diverter, the water enters an open cup and creates resistance forces that are substantially equally distributed along the internal surface of the cup. Additionally, the symmetry can substantially equally distribute turbulence forces around the outer surface of the reversible diverter and an accompanying lure. This equal distribution results in a repetitive, undulating motion. Alternatively, where the reversible diverter is slanted, notched, irregular, or where symmetry is otherwise reduced, water enters the open cup and forces are unequally distributed. Additionally, water that is diverted around a lure assembly may not equally distribute the turbulence. The unequal pressure and resistance forces can result in a less regular motion. For example, the motion of a lure assembly comprising an irregular reversible diverter (e.g. reversible diverter 10c, 10e) can appear random or chaotic. It will also be appreciated that an irregular cup may also be configured or adapted to affect the frequency and/or amplitude of the movement on a lure. For example, in some embodiments, an irregular cup creates a substantially repeated motion having an increased frequency and/or strength of motion over a symmetrical cup.

It is well known in the art that lures which imitated wounded bait fish have been successful in stimulating the striking instincts of various fish. Wounded bait fish motion is unpredictable and seemingly random. Consequently, in embodiments where a reversible diverter creates random motion on the lure, the lure may imitate a wounded bait fish. The wounded bait fish motion induced by a reversible diverter can, accordingly, arouse the natural striking instincts of the fish, thereby increasing the effectiveness of the lure or bait.

Sill another alternative embodiment of an irregular reversible diverter is illustrated in FIGS. 6A and 6B. In the illustrated embodiment, reversible diverter 10d is configured to produce added motion on a lure assembly. Reversible diverter 10d has a cup 14d which is positioned in a first, open position and which is convex with respect to sleeve 12d. Cup 14d can also be reversible. In this embodiment, cup 14d is substantially bell-shaped or conical, and has an orifice 60 formed in the wall thereof. As a result, water can flow through a side of cup 14d and between the exterior and interior of cup 14d. It will be appreciated, however, that a variety of other configurations are contemplated and are within the scope of a reversible diverter having a hole in a surface thereof. For example, it is not necessary that orifice 60 extend fully through the tubular wall of cup 14d, and orifice 60 may only partially extend through tubular wall of cup 14d such that orifice 60 forms a depression in the interior or exterior surface of the tubular wall. Additionally, one or more orifices 60 may be formed in the wall of cup 14d. Further still, while the illustrated orifice 60 is circular, it will be appreciated that this feature is not limiting. Orifice 60 can be any of a variety of other shapes, including oval, square, diamond-shaped, and the like.

An advantage to reversible diverter 10d with orifice 60 is still another alternative motion which can be created on a lure. As described previously, when reversible diverter 10d is in a frontal position, it passes through the water in front of a lure, and water enters therein creating resistance and forces tending to cause motion by an accompanying lure. Generally, water that enters a cup must exit out the cup at proximal end 18 where it is then displaced around a lure assembly. In this embodiment, however, water can be displaced around a lure assembly through orifice 60, or water can enter cup 14d through orifice 60. Accordingly, the internal and external pressure forces are disrupted and may create uneven flow into and around cup 14d. Consequently, instead of producing a repeated side-to-side motion, reversible diverter 10d can create a more chaotic, random motion. As described above with respect to other irregular reversible diverters, this random motion can mimic a wounded bait fish and cause stimulate the instincts of a fish, thereby causing it to attack or bite the lure or bait.

As will be appreciated, orifice 60 may be placed in a variety of locations on cup 14d, and may be any of various sizes and shapes. The movement that reversible diverter 10d creates on a lure assembly can be varied based on that position, size, and/or shape of orifice 60. For example, instead of creating a random motion, orifice 60 can increase the frequency or amplitude of an oscillating motion. In still other embodiments, hair, feathers, or other materials can be extended through orifice 60, and can attract a fish or further modify the motion of a lure.

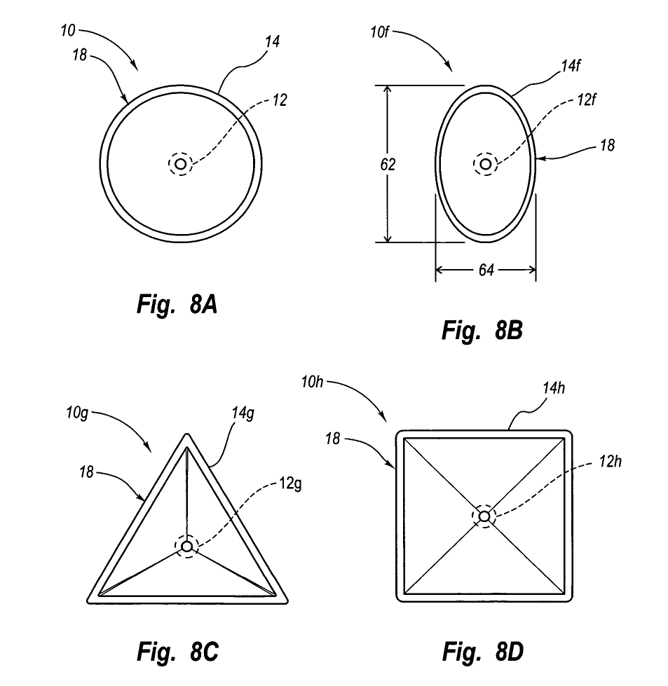

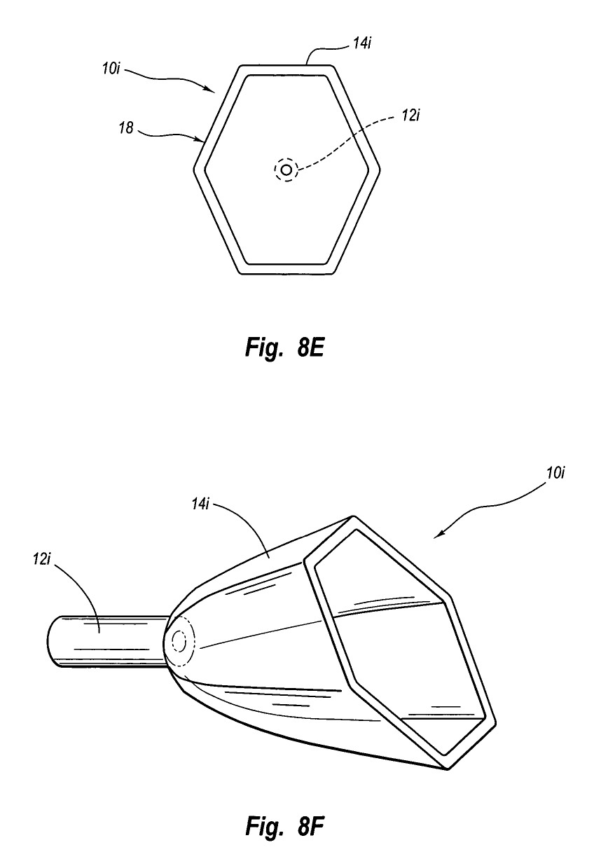

FIGS. 8A-8F illustrate views of additional embodiments of the present invention, as viewed from a proximal end of a reversible diverter. In FIG. 8A, cup 14 and sleeve 12 are substantially circular. Many lure assemblies can include hook shanks or heads having generally circular cross-sectional shapes. As a result, a feature of sleeve 12 in the illustrated embodiment is that reversible diverter 10 can receive and evenly encircle a circular portion of a lure. Where sleeve 12 is made of a flexible material, sleeve 12 can flex and stress evenly around a larger circular portion, thus reducing the risk of higher localized stresses which could result in tears of the flexible material. However, it is also contemplated that sleeve 12 have any variety of cross sectional shapes.

Also as illustrated, cup 14 has a generally circular shape. Accordingly, cup 14 has an infinite number of axes of symmetry. Symmetry can be desirable for various reasons. For example, as noted above, as water is diverted by cup 14, the symmetry of cup 14 can facilitate a substantially even displacement of water around cup 14, thus creating a predictable, oscillating motion. In some embodiments, this predictable motion is a repetitive side-to-side motion, up-and-down, or other motion which simulates the natural motion of a bait fish.

The circular shape of cup 14 is also advantageous for lures having generally round cross-sectional shapes. When an angler positions reversible diverter 10 over a round lure, such as in FIG. 3B, reversible diverter 10 can flex or evenly encircle the lure. For example, where cup 14 is placed over a round artificial fly, cup 14 can secure the tie-in point by evenly compressing areas near the head of the fly.

Cup 14f, as illustrated in FIG. 8B, has a substantially oval shape. In the illustrated embodiment, oval cup 14f has a major axis 62 and a minor axis 64. As illustrated, major axis 62 can be longer than minor axis 64, thus producing an elongate shape. It will be appreciated that an elongate shape may be vertical, horizontal, or diagonal, and that minor axis 64 may, in some embodiments, be longer than, or about the same length as, major axis 62. As will be appreciated by one having ordinary skill in the art, a variety of shapes with major and minor axes are within the scope of this invention. In alternative embodiments, a cup may have, for example, an elliptical or octagonal shape. For instance, in the embodiment illustrated in FIGS. 8E and 8F, a reversible diverter 10i comprises an elongate, substantially hexagonally-shaped cup 14i, extending from a sleeve 12.

A particular feature of a reversible diverter having a major axis larger than a minor axis is that the reversible diverter can be more effectively used with narrow lures. Many lures are tall and narrow, and do not have circular cross-sections. Accordingly, when a circular cup is positioned over the lure body in a closed, rear position, it may not conform to the shape of the lure as naturally as an oval or other cup having an elongate shape. Accordingly, cup 14f or cup 14i, each having elongate shapes, can more closely approximate and conform to the shape of the narrow lure and streamline flow around water when positioned in a closed position.

As illustrated, cup 14f has two axes of symmetry. As noted, greater symmetry in cup 14f often creates a more predictable, repetitive motion. Accordingly, reversible diverter 10f can be configured to have an oscillating motion which simulates the natural swimming pattern of a bait fish.

In still other embodiments, such as those illustrated in FIGS. 8C and 8D, a reversible diverter 10 may have a cup or sleeve with still other cross-sectional shapes. For example, in FIG. 8C, reversible diverter 10g includes sleeve 12g attached to cup 14g. Cup 14g has a triangular shape. In this embodiment, the triangular shape of cup 14g is substantially equilateral, although it will be appreciated that other configurations are within the scope of this invention, including isosceles and scalene triangles. It will also be appreciated that the shape of cup 14g can be configured to be more or less symmetrical, and that cup 14g may produce a repetitive or substantially random motion on a lure.

As illustrated in FIG. 8D, reversible diverter 10h includes a sleeve 12h coupled to a cup 14h having a square or diamond shape. As will be appreciated by one having ordinary skill in the art, the illustrated embodiment is only a representation of one of many possible shapes of cup 14h. Other polygonal shapes are also within the scope of the present invention, including rectangles, trapezoids, and other regular and irregular polygons.

A fishing lure assembly of the present invention may comprise any of the foregoing described diverters in any combination with any of the previously described lures. Thus, a lure assembly of the present invention comprises a diverter configured to be directly mounted on, or otherwise used in conjunction with, a lure. The diverter of FIG. 1, for example, can be sold or stored in conjunction with a hook or another lure as a kit, while being mounted thereon or without being mounted thereon.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

I claim:

1. A reversible device configured for use on a fishing lure, the reversible device having first and second positions, the reversible device comprising:
a sleeve configured to be mounted on a lure; and
a cup coupled to the sleeve, the cup having an interior passageway therethrough that communicates with an interior passageway in the sleeve, and wherein the cup is reversible with respect to its position to the sleeve.

2. The reversible device as recited in claim 1, wherein the cup has first and second positions.

3. The device as recited in claim 2, wherein the cup is adapted to move between the first and second positions through the application of manual pressure.

4. The device as recited in claim 2, wherein the cup is convex in the first position, and concave in the second position.

5. The device as recited in claim 2, wherein the cup induces motion on a fishing lure when the cup is selectively positioned in the first position.

6. The device as recited in claim 5, wherein the created motion is at least one of: oscillating or random.

7. The device as recited in claim 1, wherein the cup is irregular in shape.

8. The device as recited in claim 7, wherein the cup portion has an orifice in a wall thereof.

9. The device as recited in claim 7, wherein the cup is slanted.

10. The device recited in claim 1, wherein the cup extends integrally from the sleeve.

11. The device recited in claim 1, wherein the cup is light permeable.

12. A flexible diverter for use in a lure assembly, the diverter having a plurality of positions, the diverter comprising:
a reversible cup having an interior passageway; and
a flexible sleeve integrally extending from the reversible cup, the sleeve having an interior passageway that communicates with the interior passageway of the cup, the flexible sleeve being configured to expand to receive varying sizes of lures.

13. The diverter as recited in claim 12, wherein the cup is selectively positionable in at least a frontal position and a rear position.

14. The diverter as recited in claim 13, wherein the reversible cup, when in the frontal position, induces oscillating motion on a fishing lure.

15. The diverter as recited in claim 13, wherein the reversible cup does not substantially affect the motion or appearance of a fishing lure when in the rear position.

16. The diverter as recited in claim 12, wherein reversible cup is manually invertible.

17. The diverter as recited in claim 16, wherein the reversible cup is configured to resist reversal when underwater.

18. A lure assembly having a plurality of operative configurations providing for selective motion of the lure assembly, the lure assembly comprising:
a lure, wherein the lure comprises a hook; and
a diverter having a cup, wherein the diverter is used in conjunction with the lure, and wherein the cup is selectively reversible.

19. The lure assembly as recited in claim 18, wherein the diverter further comprises a sleeve having an interior passageway therethrough, the sleeve integrally extending from the cup such that the interior passageway of the sleeve communicates with an interior passageway of the cup, the sleeve being configured to mount the cup on the lure.

20. The lure assembly as received in claim 19, wherein the diverter further comprises a junction between the cup and sleeve, the junction being positioned substantially adjacent an eye of the hook.

21. The lure assembly as recited in claim 18, the lure further comprising a tube mounted on the hook and diverter.

22. The lure assembly as recited in claim 18, the lure further comprising a wire mounted on the hook and diverter.

23. The lure assembly as recited in claim 18, wherein the lure comprises a body configured to attract a fish, the diverter being mounted on the body.

24. The lure assembly as recited in claim 23, wherein the diverter integrally extends from the body.

25. The lure assembly recited in claim 23, wherein the body is coupled to the hook.

26. The lure assembly recited in claim 23, wherein the body comprises one or more fly tying components.

27. The lure assembly recited in claim 26, wherein the one or more fly tying components are secured to the hook at a tie-in point, and wherein the cup has a plurality of positions, wherein in at least one of the plurality of positions, the cup covers the tie-in point.

28. The lure assembly recited in claim 18, wherein the diverter is directly mounted on the lure.

29. The lure assembly recited in claim 18, wherein the diverter is indirectly mounted on the lure.

30. A fishing lure kit, comprising:
a lure, wherein the lure comprises a hook; and
a diverter configured to be used in conjunction with the lure, the diverter having a cup, and wherein the cup is selectively reversible, such that the diverter can be used in conjunction with the lure to thereby form a lure assembly having a plurality of operative configurations.

31. The fishing lure kit as recited in claim 30, wherein the diverter can be mounted on the lure.

32. The fishing lure kit as recited in claim 30, wherein the diverter further comprises a sleeve adjacent the cup, the sleeve having an interior passageway therethrough such that the interior passageway of the sleeve communicates with an interior passageway of the cup, the sleeve being configured to mount the diverter on the lure.

33. The fishing lure kit as recited in claim 30, wherein the plurality of operative configurations facilitates the selective alteration of the underwater motion of the lure assembly.
